(19) United States
(12) Patent Application Publication
(10) Pub. No.: US 2004/0139185 A1
(43) Pub. Date: Jul. 15, 2004

(54) Decoupling a protocol from its implementation

(76) Inventor: Wasilios Souflis, Stuttgart (DE)

Correspondence Address: PERMAN & GREEN, 425 POST ROAD, FAIRFIELD, CT, 06824, US

(21) Appl. No.: 10/331,741

(22) Filed: Dec. 30, 2002

(51) Int. Cl. G06F 15/173

(52) U.S. Cl. 709/223; 709/203

(57) ABSTRACT

A method for performing a measurement where a measurement protocol is decoupled from its implementation. The protocol comprises at least one command that is called by a client and is sent to a server. The command is mapped by the server to an implementation for the command, wherein the implementation is choosen depending on the result of a context sensitive evaluation of the command.

### BACKGROUND OF THE INVENTION

1. Field of the Invention

The invention relates to a method for performing remote measurements.

2. Brief Description of Related Developments

Measurement environments are known on the market and are used e.g. for testing optical devices that are intented to be used in optical networks.

### SUMMARY OF THE INVENTION

It is an object of the invention to provide an improved protocol for remote measurement sequences.

This object is solved by the method of claim 1. The object is also solved by the protocol state machine of claim 6.

Remote measurement environments allow measurements to be initiated and controlled by a remote process. Such remote measurement environments can be realized according to a client/server architecture where a client sends a set of commands to a server. The server performs the measurements according to the commands received from the client by controlling a test board.

The set of commands that are sent by the client to initiate and control a specific measurement constitute a so called measurement sequence. Each command of a measurement sequence is part of the server's measurement protocol which comprises all available commands. At least when the measurements are finished the server returns the generated and processed measurement results to the client. It is also possible that the client requests data at different stages of the measurement sequence, e.g. for debugging reasons.

Measurement environments for optical devices can allow to perform different kinds of measurements like group delay, chromatic dispersion, or polarization mode dispersion. Implementing a specific measurement sequence on a client therefore needs specific knowledge about the structure of the test board and the interfaces between the test board and the server, e.g. which data acquisition card to choose and how to initialze it.

The invention allows the client to call the same commands within different measurement sequences even if not the same effect has to be achieved. Nevertheless, the measurement protocol is designed to only allow using the same commands if similar or somewhat related effects are intended. The server therefore interprets each command that is received from the client by incorporating a context sensitive evaluation scheme. Depending on the result of the context sensitive evaluation the command is mapped to an appropriate implementation which then is executed to perform the desired effect. As a result, the protocol gets more clear and manageable. This simplifies the implementor's work and makes the client code that implements a measurement sequence easier to maintain.

The invention also allows to hide internals from the client like details of the test board or which data acquisition card to choose and how to initialize it. Since each command is decoupled from its implementation the internal knowledge is added when the command is mapped to an appropriate implementation by the server. This again simplifies the implementor's work.

Moreover, internal changes do not neccessarily affect the client code. For example, a data acquisition card can be replaced by another type without being noticed by the client.

A protocol state machine is run on the server and switches between states depending on the command currently received from the client. For each state of the protocol state machine there exists a list of all valid commands. Commands that have the same name but are intended to cause different effects can be differentiated by the current state of the protocol state machine. When a command is mapped to an appropriate implementation the current state of the protocol state machine is taken into account. This constitutes a context sensitive evaluation scheme.

Further embodiments of the invention are provided in the dependent claims. In particular, it is emphasized that the invention may also be realized by a computer program or a computer program product which is able to execute the method of claim 1 when run on a data processing system.

### BRIEF DESCRIPTION OF THE DRAWINGS

FIG. 1 is a schematic block diagram of an environment for performing remote measurements;

FIG. 2 shows a simplified state transition diagram of a protocol state machine;

FIG. 3a shows a table that displays the state transitions that are induced by the command ArmETM;

FIG. 3b shows a table that displays the state transitions that are induced by the command reset, and

FIG. 4 shows a table that displays for each state of the protocol state machine of FIG. 2 a list of valid commands.

### DETAILED DESCRIPTION OF THE PREFERRED EMBODIMENT(S)

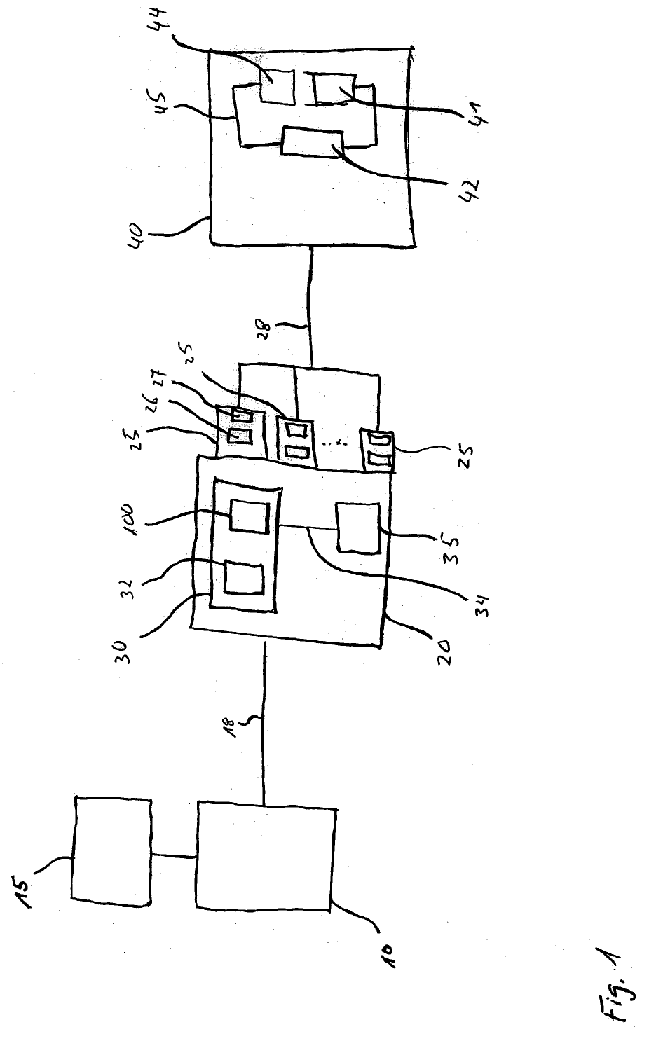

FIG. 1 shows a measurement environment 5 for performing measurements with optical devices where the measurements are inititated and basically controlled remotely. The optical devices are used in optical networks. The measurement environment 5 comprises a client 10 that is connected via a signal line 18 with a server 20. The signal line 18 can be realized for example by a bus system (e.g. FireWire, USB) or a network (e.g. LAN, WLAN). In this embodiment the client 10 is a personal computer (pc) that is connected with a monitor 15. and the server 20 is an industrial personal computer (ipc). Following the idea of a client/server architecture, both, the client and the server could also be totally realised on the same computer, e.g. by different processes that communicate via a standardized interface.

The server 20 comprises a micro processor 35 that is connected by a bus system 34 to a memory unit 30. The memory unit 30 for example is embodied as a random access memory (RAM) and comprises an area where the protocol state machine 100 is stored and an area that holds for each command a set of available implementations, the so called library of implementations 32. The server 20 also comprises several data acquisition cards that are all denoted by the identifier 25 in FIG. 1. Each data acquisition card comprises an optical-electrical converter 27 and an electrical preamplifier 26. The data acquisition cards 25 are connected via a signal line 28 with a test board 40. The test board 40 comprises a laser 41 and a receiver 44. Both are connected via optical signal lines 45 with the optical device under test (dut) 42.

The measurement environment 5 works as follows:

The client 10 runs an application program which implements a measurement sequence for the appropriate device under test 42. To control a specific measurement each measurement sequence comprises a set of commands. Each command that is called by the client 10 is transferred to the server 20 via the signal line 18.

Each command the server 20 receives is mapped to an implementation. For that purpse the server 20 performs a context sensitive evaluation of the command using the protocol state machine 100 and then executes the matching implementation choosen out of the library of implementations 32.

According to the choosen implementation the server 20 then performs appropriate actions like activating a data acquisition card 25 eventually with an adequate set of parameters depending on the commands that are sent by the client 10. The server also causes the test board 40 to perform the measurements. The results of the measurements are collected via signal line 28 and the data acquisition card 25. Depending on the current measurement sequence that is initiated by the client 10 the server 20 returns the data to the client 10 directly or performs some further processing, e.g. by collecting and averaging or by interpreting the data according to the current kind of measurement.

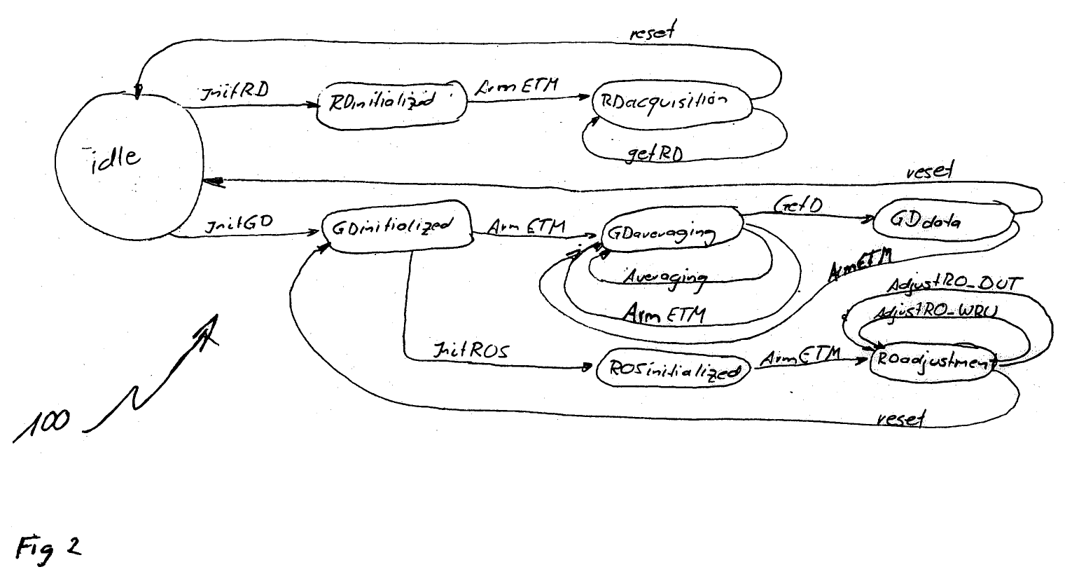

FIG. 2 shows a simplified state transition diagram of a protocol state machine 100 that is implemented on the server 20. Each box represents a state of the protocol state machine 100. Each state is referred to by some text that is located in the box. Each arrow that connects two boxes represents a command sent by the client 10. If the protocol state machine 100 identifies a command, it switches to a state that follows next to this command in the simplified state transition diagram of FIG. 2 according to the direction that is indicated by the appropriate arrowhead.

When the protocol state machine 100 is started on the server 20 it waits in a state idle for a command from the client 10. If the client 10 for example wants to perform measurements that are based on raw data like an absolute intensity of a signal that has passed the device under test 42, it sends a command InitRD to the server 20. The server 20 then interprets the command InitRD, e.g. by calling a predefined routine that evaluates the arguments of the command and initialzes the measurement environment accordingly. The protocol state machine 100 then switches to a state RDinitialized.

If the client 10 then sends a command ArmETM, the server 20 initializes an appropriate data acquisition card 25 and switches into a state RDacquisition. In the state RDacquisition two commands are allowed. A command getRD causes the server 20 to read the measurement data from the data acquisition card 25, to send this data to the client 10, and to stay in the state RDacquisition. A command reset causes the protocol state machine 100 to switch back to the initial state idle.

The second measurement sequence that is illustrated in FIG. 2 concerns the measuring of group delays. A group delay describes the effect that is caused by chromatic dispersion of signals (i.e. impulses of light) that are transmitted through a fibre or an optical device. Chromatic dispersion means that different frequencies are delayed differently if they are transmitted through the same fibre or the same optical device.

A group delay measurement is started by the client 10 by sending a command InitGD to the server 20. The server 20 maps this command to an appropriate implementation by evaluating the current state of the protocol state machine 100. When executing the choosen implementation the arguments that are passed by the command InitGD are also taken into effect. These arguments for example define a number of samples that have to be taken, a minimum (e.g. 1550 nm) and a maximum (e.g. 1555 nm) wavelength, and a step (e.g. 10 pm) which is the value that is added each time the wavelength is increased. The protocol state machine 100 reflects this initialization by switching to a state GDinitialized.

The data acquisition cards 25 comprise an optical-electrical converter and an electrical preamplifier. Depending on the current measurement sequence and the current device under test 42 the quantity of the optical values returned from the test board 40 will vary. Typically, the data aquisition cards 25 only provide meaningful measurement results if the range of the output values of the optical-electrical converter is adapted to meet the range of input values of the electrical preamplifier. Thus, an offset has to be determined and the optical-electrical converter has to be adjusted by this offset. In addition, a range that bounds the expected measurement results has to be determined and the data acquisition card 25 have to be calibrated according to this range so that the resolution of an input signal is maximized.

The client 10 starts the necessary offset and range scan by calling a command InitROS. When the command InitROS is executed by the server, the protocol state machine 100 jumps to a state ROSinitialized. Now, the client 10 calls the command ArmETM. This is the same command as is called within the measurement sequence for raw data acquisition when the protocol state machine 100 is in the state Rdinitialzed. Here, the client 10 simply can instruct the server 20 to arm an appropriate data acquisition card 25 without having to deal with details like which data acquisition card to use or which variables to initialze. The server 20 then adds the relevant details by mapping a received command to the appropriate implementation. Therefore the server 20 evaluates a current state of the protocol state machine 100. This constitutes a context specific mapping of a command to an implementation and simplifies the development of measurement sequences at the client side by hiding implementation details.

After mapping the command ArmETM to an appropriate implementation and executing this implementation, the protocol state machine 100 switches to a state ROadjustment Now, the client 10 calls a command AdjustRO_DUT and a command AdjustRO_WRU to adjust the range offset of the device under test 42 and a wavelength reference unit, respectively. Both commands cause the protocol state machine 100 to reside in state ROadjustment To return from the current branch of the protocol state machine 100 the client 10 calls the command reset. This causes the protocol state machine 100 to switch back to the state GDinitialized.

Performing group delay measurements requires that a data acquisition card is armed in an appropriate way. Thus, the client 10 again calls the command ArmETM. The server 20 then evaluates the current state of the protocol state machine 100, selects and executes the matching implementation, and switches to a state GDaveraging. Here, the client 10 causes the server 20 to perform several measurements. Possible commands in this state comprise for example Averaging, ArmETM, and GetD. If the server 20 receives the command ArmETM, it again arms a data acquisition card 25 depending on the current context that is determined using the protocol state machine 100. The protocol state machine 100 stays in state GDaveraging. If the client asks for the results of some measurements by sending a command GetD the protocol state machine 100 switches to state GDdata. Now, the client 10 can bring the server 20 to proceed with doing measurements by sending the command ArmETM again. In this case, the protocol state machine 100 switches back to state GDaveraging. However, if the client wants to terminate the measurement session it sends the command reset which induces the server to run some procedures for cleaning up, for example by reseting some variables, and causes the protocol state machine 100 to switch back to the state idle.

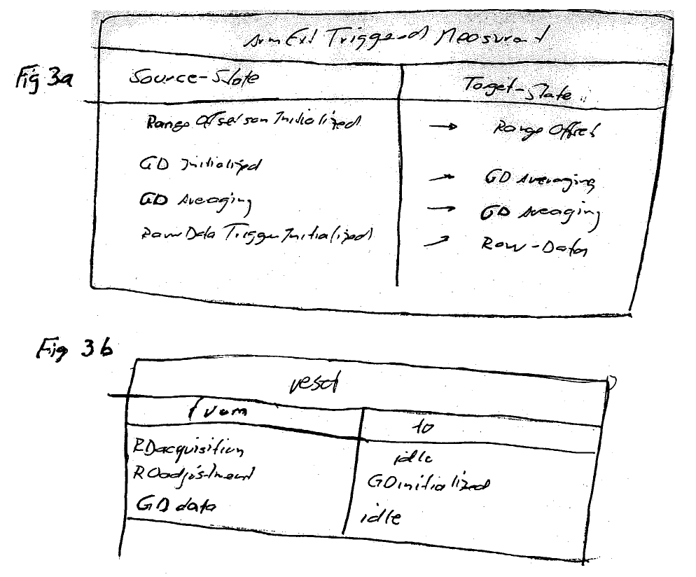

As shown in FIG. 2 it is valid to call the command ArmETM by the client while the protocol state machine 100 of the server 20 is in different states. The same holds for the command reset Thus, both commands need to be mapped to different impelementations depending on the current context. This is done by evaluating the current state of the protocol state machine 100. In FIG. 3a the state transitions of the command ArmETM are listed as are explained in FIG. 2. Accordingly, in FIG. 3b the state transitions of the protocol state machine 100 are listed that are induced by the command reset. In both figures, 3a and 3b, the first column gives the source states, i.e. the states in which the protocol state machine 100 has to be such that the appropriate command (ArmETM or reset, respectively) is valid. The second column gives the states the protocol state machine 100 switches to after the command is interpreted by the server 20.

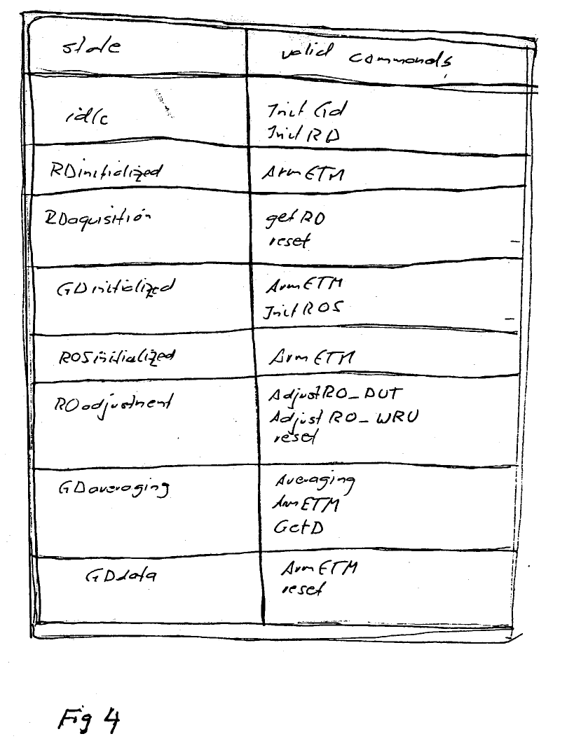

FIG. 4 shows a table as is implicitly available by an implementation of the protocol state machine 100. This table includes for each possible state of the protocol state machine 100 a list of valid commands. Each entry in the first column of the table refers to a possible state of the protocol state machine 100 and each corresponding entry in the second column is the associated list of valid commands. This table illustrates that the protocol state machine 100 enables an efficient error handling. In a first step an error handler can easily check whether a command that is sent by the client 10 is valid at all simply by evaluating the current state of the protocol state machine and checking whether the command is available in the list of valid commands. If the command is valid in a second step further errors can be handled context sensitive, i.e. by evaluating the current state of the protocol state machine 100 and executing an error routine that takes the kind of error and the current state of the protocol state machine 100 into account.

What is claimed is:

1. A method for performing a remote measurement comprising at least one command that is called by a client and is sent to a server, wherein the command is mapped by the server to an implementation of the command, wherein the command is choosen depending on the result of a context sensitive evaluation of the command.

2. The method of claim 1 comprising a protocol state machine adapted to switch between states depending on a respective command currently in process, wherein the context sensitive evaluation comprises a step of analyzing the current state of the protocol state machine.

3. The method of claim 2 wherein the protocol state machine is also used for error handling.

4. The method of claim 3 wherein the error handling depends on the current state of the protocol state machine.

5. The method of claim 3 wherein the error handling is performed by determining whether the command currently in process is valid.

6. A protocol state machine for performing a remote measurement comprising a context sensitive evaluation of commands that are part of a measurement sequence and are sent by a client to a server wherein the protocol state machine is adapted to switch between states depending on a respective command currently in process.

7. The protocol state machine of claim 6 wherein the protocol state machine is also used for error handling.

8. The protocol state machine of claim 7 wherein the error handling depends on the current state of the protocol state machine.

9. A computer program or a computer program product preferably stored on a data carrier, for executing the method of claim 1 when run on a data processing system such as a computer.

10. A computer program or a computer program product preferably stored on a data carrier, that implements the functionality of the protocol state machine of claim 6.
